(19) United States
(12) Patent Application Publication
(10) Pub. No.: US 2004/0121799 A1
(43) Pub. Date: Jun. 24, 2004

(54) MOBILE PHONE FOR INFORMING USERS OF RADIATION POWER LEVELS

(76) Inventor: Tzeng-Chih Chiou, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,563

(22) Filed: Dec. 22, 2003

(30) Foreign Application Priority Data
Dec. 24, 2002 (TW) 091137218

(51) Int. Cl. H04B 7/00; H04Q 7/20

(52) U.S. Cl. 455/550.1; 455/522

(57) ABSTRACT

A mobile phone for informing users of radiation power levels. The mobile phone includes a radio frequency (RF) circuit for providing a transmission signal, an antenna for radiating the transmission signal in radio waves, a power measuring circuit for measuring a power level of the transmission signal, an alarm processing module, and an alarming module. According to the measured result of the power measuring circuit, the alarm processing module can control the alarming module to indicate the power level of the transmission signal with image, light, sound or vibration, such that the user is aware of the radiation power level of the mobile phone.

### BACKGROUND OF INVENTION

1. Field of the Invention

The present invention provides a mobile phone, and more specifically, a mobile phone capable of informing users of the radiation power level.

2. Description of the Prior Art

Electromagnetic (EM) radiation is generated in all kinds of wireless communication networks. However, how EM radiation impacts human health remains unknown. Wireless communication requires receiving and transmitting radio signals using a mobile phone. While receiving radio signals, the mobile phone only passively receives signals and generates a negligible amount of power. However, while transmitting radio signals, the mobile phone can generate radio signals whose power level may result in possible radiation injury to the user of the mobile phone. There is an industry standard specifying power of radio signals applied in a mobile phone. In general, when the specific absorption rate (SAR) of radio signals of a mobile phone is under 1.6 W/Kg, possible radiation injury is believed to have no influence on human health.

In a modern wireless communication system, power of radio signals generated by a mobile phone will change throughout the whole communication operation. When the mobile phone receives radio signals generated by a base station, if the received power level is low, representing that the path loss between the base station and the mobile phone is great, the mobile phone will increase the transmitting power to maintain communication quality. On the other hand, when the power received by the base station is high, representing that the communication between the base station and the mobile phone is good enough, the base station will command the mobile phone to decrease the power of radio signals so as to reduce the current consumption of the mobile phone.

In other words, during the wireless communication operation, the power level of radio signals generated by the mobile phone is always changing. However, in a prior art mobile phone, there is no indication of the power level of its radio signals. Since a user cannot know what the current magnitude of radiation power level of radio signals is, he will be unaware of any possible injury to his health of radiation power generated by a mobile phone. A prior art mobile phone can display the power of received radio signals of the mobile phone so that the user can be informed of the communication condition. If the mobile phone displays a low received power level indication, representing that the mobile phone cannot receive signals well, satisfied signal exchange between the base station and the mobile phone is difficult. However, a prior art mobile phone cannot display the current magnitude of power level transmitted by the mobile phone. Without proper notification of the power level the mobile phone transmitted, there is no way for a user to protect himself from possible injury of radiation power.

### SUMMARY OF INVENTION

It is therefore a primary objective of the claimed invention to provide a mobile phone capable of notifying the user of the power level that the mobile phone transmits in order to overcome the problems of the prior art.

A prior art mobile phone cannot notify the user of the power level that the mobile phone transmits to the base station for wireless communications.

In the claimed invention, a mobile phone can achieve a real-time notification to its user for the power level that the mobile phone transmits by using video displays, sounds, or vibrations so that the user can be informed about the transmitting power level to prevent any possible injury to the users health in advance.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a present invention mobile phone.

FIG. 2 is a perspective diagram of the mobile phone illustrated in FIG. 1.

FIG. 3 is a functional block diagram of another embodiment of a present invention mobile phone.

FIG. 4 is a perspective diagram of the mobile phone illustrated in FIG. 3.

### DETAILED DESCRIPTION

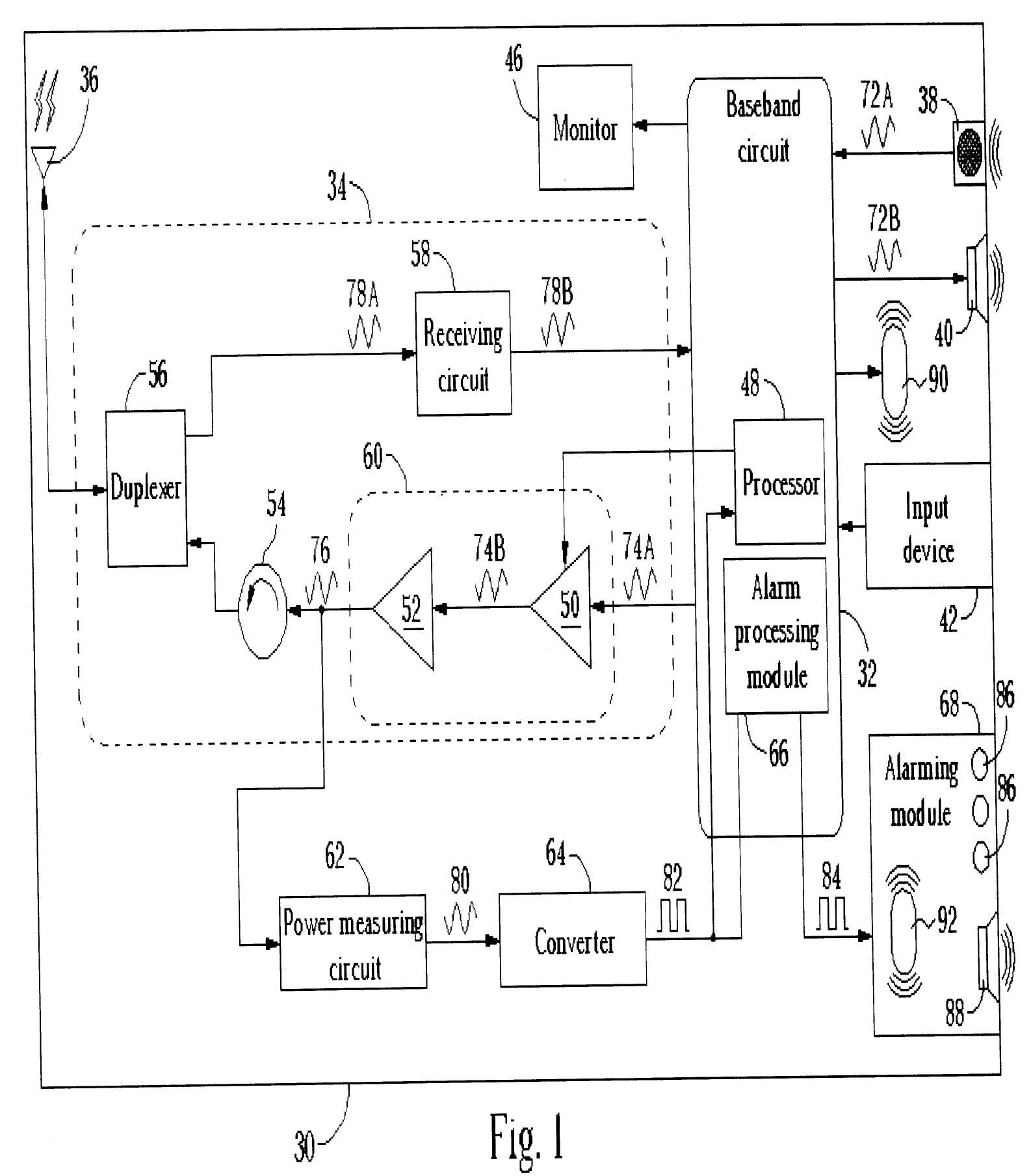

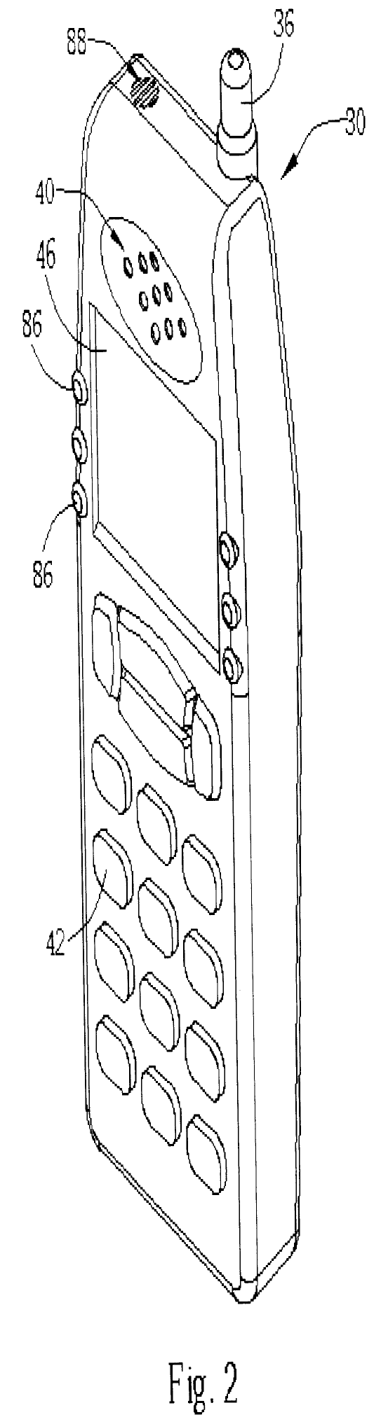

Please refer to FIG. 1 and FIG. 2. FIG. 1 is a functional block diagram of a mobile phone 30 according to a present invention. FIG. 2 is a perspective diagram of mobile phone 30 illustrated in FIG. 1. The mobile phone 30 comprises a microphone 38, a speaker 40, an input device 42, a monitor 46, a baseband circuit 32, a radio frequency circuit 34, and an antenna 36. The baseband circuit 32 comprises a processor 48; the radio frequency circuit 34 comprises a receiving circuit 58, a power modulating module 60, an isolator 54, and a duplexer 56, wherein the power modulating module 60 comprises a signal amplifier 50 and a power amplifier 52. The power measuring circuit 62 and an analog-to-digital converter 64 are provided between the radio frequency circuit 34 and the baseband circuit 32. In order to practice the present invention, an alarm processing module 66 and an alarming module 68 are provided in the mobile phone 30 for generating corresponding signals to indicate radiation power.

The processor 48 is applied to control operations of the mobile phone 30. The input device 42 can be a keypad set or a touch panel for inputting commands from a user to the processor 48 to perform functions according to the user. The monitor 46 can display operational statuses of the mobile phone 30. A complete wireless communication operation by the mobile phone can be expressed as follows: when the user uses the mobile phone 30 to perform wireless communication, his input voice signals received by the microphone 38 will be converted to an electrical voice signal 72A. Being transferred to the baseband circuit 32, the electrical voice signal 72A will be converted to a corresponding communication signal 74A and transferred to the radio frequency circuit 34. The signal amplifier 50 in the radio frequency circuit 34 can amplify the communication signal 74A so as to generate a corresponding communication signal 74B. The power amplifier 52 can further amplify power level of the communication signal 74B to become a corresponding transmission signal 76. The transmission signal 76 can pass through the isolator 54 and the duplexer 56 to the antenna 36 in which the antenna 36 can transmit the transmission signal to the communication network such as a base station. Thus, voice signals of the user can be transmitted in wireless communications by the mobile phone 30.

The antenna 36 can also receive a radio signal sent from the communication network to the mobile phone 30 wherein the radio signal will be converted to a corresponding electrical signal (receiving signal 78A) and transferred to the receiving circuit 58 via the duplexer 56. The receiving circuit 58 can apply power modulation to the receiving signal 78A so as to generate a corresponding receiving signal 78B, which will be transferred to the baseband circuit 32. The baseband circuit 32 can apply analog-to-digital converting, decoding, de-frequency or other signal arrangement to the receiving signal 78B for generating a corresponding voice signal 72B which will be transferred to the speaker 40. A sound wave corresponding to the voice signal 72B will be outputted by the speaker 40 to the user. In the above-mentioned processes, the isolator 54 is applied to protect the power transfer from the power amplifier 52 to the duplexer 56 against reflection. The reflected power from the duplexer 56 to the power modulating module 60 will be hugely reduced by the isolator to prevent damage to the power modulating module 60 by the reflecting power. The duplexer 56 can, according to different characteristics of transmitted or received signals, transmit radio signals received from the antenna 56 to the receiving circuit 58. For example, the duplexer 56 can be a filter for picking up signals belonging to a specific frequency range. Additionally, the vibrator can generate vibrations for notifying the user of the communication statuses.

Generally a prior art mobile phone can properly modify transmission power level of radio signals. For example, a mobile phone can modify transmission power levels according to the received radio signals. In the mobile phone 30, the processor 48 can control transmission power levels of radio signals by regulating the signal amplifier 50 to amplify the communication signal 74A. For example, when the processor 48 requires a transmission signal having a greater power level, the processor 48 can regulate the signal amplifier 50 to amplify the communication signal 74A by a greater gain to enable the communication signal 74B to have a bigger amplitude. Thus the transmission signal 76 will have a greater power level accordingly and will be eventually transmitted through the antenna 36. Before the communication between the mobile phone and the base station develops, the processor 48 can roughly determine what the power level of the radio signal shall be set to according to the signal power level received from the base station. If the power level of the receiving signals 78B from the base station is weak enough, the processor 48 will enhance the amplification of the signal amplifier 50 so as to increase power level of communication signal 74A to overcome poor communication condition. After the mobile phone 30 develops connection with the base station, the processor 48 can regulate the amplification of the transmitting radio signals (like communication signal 74A) by the signal amplifier 50 according to power level of the receiving radio signals (like receiving signal 78B) or by the commands sent from the base station.

A feedback control is also applied in a prior art mobile phone to maintain a proper power level of the transmitting radio signals. In the mobile phone 30, the power measuring circuit 62 and the analog-to-digital converter 64 are provided to make up such feedback control. The power measuring circuit 62 can be a current sensor or a power detector for measuring power level of the transmission signal 76 and generating a corresponding result 80. The processor 48 can, according to the result 80, control the amplification of the signal amplifier 50. For example, if the power measuring circuit 62 detects that the power level of the transmission signal 76 is too high, the processor 48 can reduce the amplification of the communication signal 74A by regulating the signal amplifier 50 so as to reduce the power of the transmission signal 76. In order to easily apply amplification control with the processor 48 according to the result 80 generated by the power measuring circuit 62, the result 80 can be transmitted to an analog-to-digital converter 64 for converting an analog analytic result 80 to a digital analytic result 82 and then transmitted to the processor 48.

Since the above-mentioned feedback control uses the power measuring circuit 62 for measuring the power level of the transmission signal 76, the present invention can notify the user of the transmitting power level of the mobile phone 30 by indicating the digital analytic result 82. The alarm processing module 66 provided in the mobile phone 30 can generate alarming signals corresponding to the digital analytic result 82 by indicating the power of the transmission signal 76 in video displays, sounds, or vibrations. At least one light emitting diode 86, speaker 88, or vibrator 92 can be provided in the alarming module 68 for indicating transmitting power level. For example, the alarm processing module 66 can set up a predetermined power level segment for each light emitting diode 86 illustrated in FIG. 1 and FIG. 2. The analytic result 82 will be displayed in a form of the number the light emitting diode 86 lightened. For example, in the embodiment illustrated in FIG. 1, there are three light emitting diodes 86 respectively predetermined to represent 5, 10, and 15 dBm power level values. If the digital analytic result 82 shows that the power level of the transmission signal 76 is 7 dBm, only one light emitting diode 86 will be lightened. If the power level of the transmission signal 76 rises to 12.5 dBm, two light emitting diodes 86 will then be lightened to notify the user. Besides, the alarm processing module 66 can also control the flashing pattern of the light emitting diode 86 at different power levels of the digital analytic result 82. For example, the light emitting diode 86 can flash at a lower frequency when the power level of the transmission signals is lower, and the light emitting diode 86 can flash at a higher frequency when the power level of the transmission signals is higher. Thus, even if there is only one light emitting diode provided in the mobile phone 30, the radiation power level can be clearly indicated to the user. As illustrated in FIG. 2, the light emitting diode is positioned outside the shell for the user to see.

A speaker 88 can be provided in the alarming module 68 for providing sounds according to analytic results. For example, when the power level detected by the power measuring circuit 62 rises over a predetermined value, the alarm processing module 66 can generate an alarming signal 84 directing the speaker 88 to generate sounds which indicate that the power level has risen over the predetermined value. The speaker 88 can generate different sounds according to different power level values, which can be controlled by the alarm processing module 66. For example, if the power level of the transmission signal 76 is below 0 dBm, the speaker 88 will not generate sounds. When the power level rises to the range between 10 dBm to 20 dBm, the speaker 88 will generate a low frequency alarming sound. When the power level rises over 20 dBm, the speaker 88 will generate higher and more rapid sounds to inform the user of the rising power level. According to the same theory, the alarming module 68 can include the vibrator 92 for indicating the power level of the radio signals of the mobile phone in different vibration patterns. In the embodiment illustrated in FIG. 1, the speaker 88 and the vibrator 92 are provided in addition to a vibrator 90 and the speaker 40 used for normal operation of the mobile phone 30.

As mentioned above, the alarm processing module 66 can control the alarming module according to different predetermined power levels for providing different types of signals such as video signals, sounds, or vibrations. The predetermined power levels of the alarm processing module 66 in the mobile phone 30 can be determined by the manufacturer or the user. A memory can be applied to store the settings. The user can set up the settings using the input device 42, and the settings will be stored in the memory. The memory is capable of being accessed by the alarm processing module 66, so that the alarm processing module 66 can regulate the alarming module 68 according to the settings.

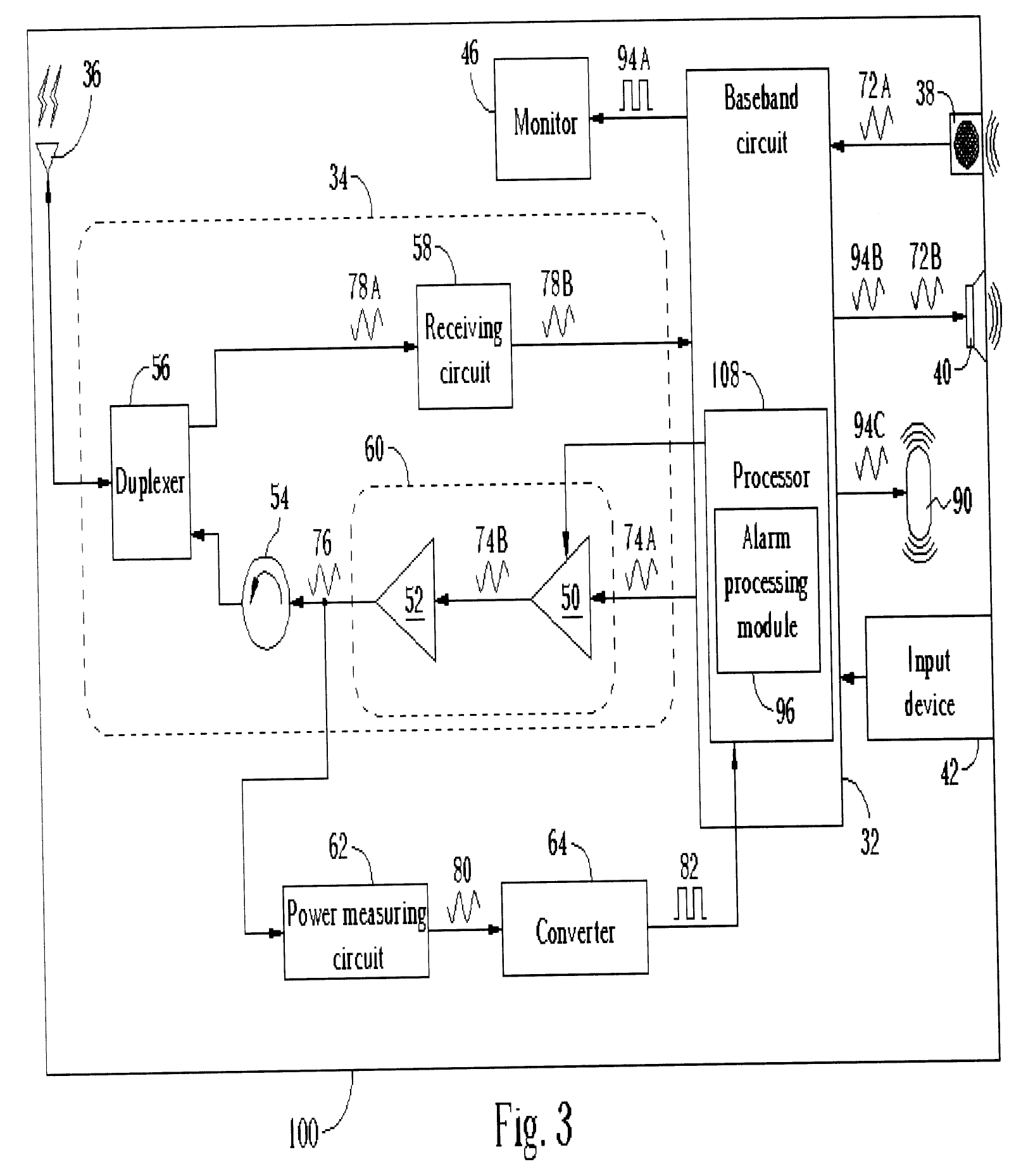

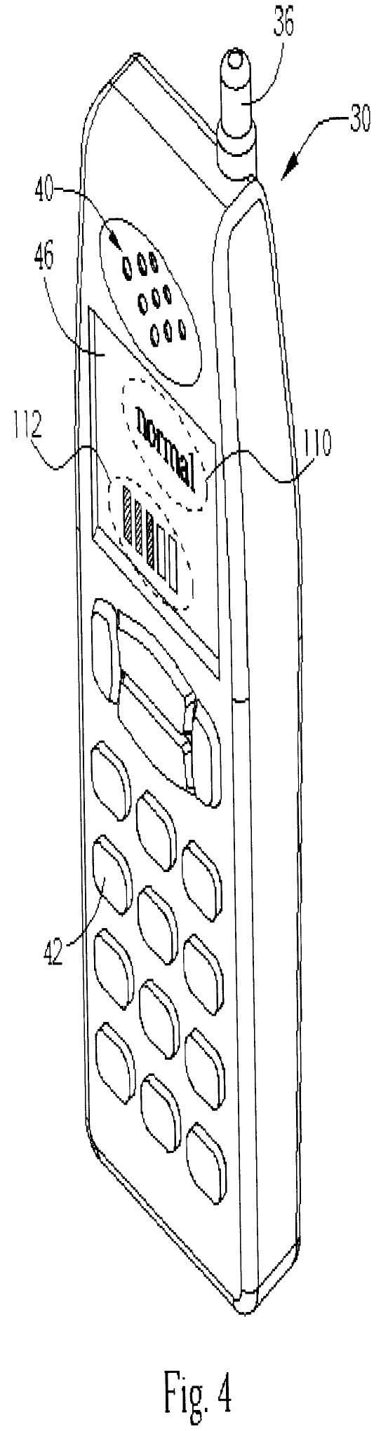

Please refer to FIG. 3 and FIG. 4. FIG. 3 is a functional block diagram of another embodiment of a present invention mobile phone 100. FIG. 4 is a perspective diagram of the mobile phone 100 illustrated in FIG. 3. In order to simplify the disclosure of the present invention, identical devices used in FIG. 3 and FIG. 4 use the same numbers and names as those used in FIG. 1 and FIG. 2. For example, in FIG. 3 and FIG. 4, the microphone 38, the speaker 40, the vibrator 90, the input device 42, the monitor 46, the baseband circuit 32, the radio frequency circuit 34, the antenna 36, the power measuring circuit 62, the converter 64, the signal amplifier 52, and receiving circuit 58 are all used. In the mobile phone 100, the processor 108 can control the amplification on the communication signal 74A by regulating the signal amplifier 50 so as to control the radiation power level of the mobile phone 100. The difference between the mobile phone 100 and the mobile phone 30 is that in the mobile phone 100, functions of the alarming processing module 96 are performed by the processor 108, and the alarm processing module 96 can directly use the monitor 46, the speaker 40, and the vibrator 90 provided in the mobile phone 100 for indicating the power level of the transmission signals. In other words, the indication function of the alarming module is combined with the monitor 46, the vibrator 90, or the speaker 40.

Generally, a mobile phone utilizes a memory for storing program codes or firmware, and a processor operates according to the program codes or firmware. In the mobile phone 100, the alarm processing module 96 can contain program codes or firmware. When the processor 108 executes these program codes or firmware, functions of the alarm processing module 96 can be performed by generating alarming signals 94A, 94B, and 94C for respectively controlling the monitor 46, the speaker 40, and the vibrator 90 to indicate the radiation power level of the mobile phone 100. For example, the speaker 40 can not only output voice signals during communication, but can also generate different kinds of alarming voices according to the analytic result 82 to inform the user of the power level of radio signals of the mobile phone 100. Certainly, the alarming voices can be certain speech sounds like “the power level is normal”. The vibrator 90 can generate different vibration patterns according to the power level of transmission signals. The monitor 46 can not only display information about operations of the mobile phone 100, but can also, under control of alarming signal 94 generated by the processor 108, display video signals for indicating the power level of the radio signals of the mobile phone 100. As illustrated in FIG. 4, the monitor 46 can indicate whether or not the radiation power level generated by the mobile phone 100 is in a normal level by using texts or a number of black square blocks 112. Additionally, the power level of the transmission signal 176 and the SAR have a certain mathematical relationship. When the processor 108 performs functions of the alarm processing module 96, the analytic result generated by the power measuring circuit 62 can be converted to a corresponding SAR according to the mathematical relationship, and the SAR can be displayed on the monitor 46. Please notice, that the pattern of the blocks 112 displayed in FIG. 4 displays the power level of the transmission signals, but not the power level of the received signals.

In a prior art mobile phone, a user can only be informed of the condition of received signals without any possibility of knowing the radiation power level and avoiding possible injury. In the present invention, a power reflection control is applied for concretely indicating the radiation power level by using video signals, sounds, or vibrations such that the user can be informed of the power level of transmission signals. If the user thinks that the power level is too high, he can temporarily stop using the mobile phone or try to change the communication environment such as changing his location. Once the communication environment gets better, the mobile phone can properly reduce the power level to avoid possible injury to the users. In other words, the present invention can inform the user of the radiation power level to avoid possible health injuries, and the user can more wisely use the communication network to ensure his health. Moreover, the present invention can be applied in other kinds of radio devices, and is not limited to mobile phones.

Those skilled in the art will readily observe that numerous modifications and alterations of the device may be made while retaining the teachings of the invention. Accordingly, the above disclosure should be construed as limited only by the metes and bounds of the appended claims.

1. A mobile phone comprising:
a processor for controlling operations of the mobile phone;
a power modulating module for controlling a power level of a communication signal so as to generate a corresponding transmission signal;
a power measuring circuit electrically connected to the power modulating module for measuring a power level of the transmission signal so as to generate a corresponding result;
an antenna electrically connected to the power measuring circuit for generating a corresponding alarming signal according to the result; and
an alarming module electrically connected to the alarm processing module for generating a corresponding sign according to the alarming signal for indicating the power level of the transmission signal.

2. The mobile phone of claim 1 further comprising a monitor electrically connected to the processor for displaying operational statuses of the mobile phone.

3. The mobile phone of claim 2 wherein the alarming module is the monitor being capable of displaying video signals corresponding to the alarming signal.

4. The mobile phone of claim 1 wherein the alarming module comprises at least a light emitting diode, wherein when the power level of the transmission signal rises over a predetermined value, the alarming signal is capable of initiating a light emitting diode of the alarming module to emit light, and when the power level of the transmission signal drops below a predetermined value, the alarming signal is capable of stopping the light emitting diode from emitting light.

5. The mobile phone of the claim 1 wherein the alarming module comprises a vibrator for generating vibrations according to the alarming signal.

6. The mobile phone of claim 1 wherein the alarming module comprises a speaker for generating a sound according to the alarming signal.

7. The mobile phone of claim 1 wherein the power modulating module comprises:
a signal amplifier for amplifying the communication signal according to controls of the processor; and
a power amplifier electrically connected to the signal amplifier for amplifying power of the communication signal.

8. The mobile phone of claim 7 wherein the processor is capable of controlling the signal amplifier according to the result generated by the power measuring circuit.

9. The mobile phone of claim 7 wherein the antenna is capable of receiving radio signals for generating a corresponding receiving signal.

10. The mobile phone of claim 9 wherein the processor is capable of controlling the signal amplifier according to the receiving signal such that when the receiving signal changes, the amplification controlled by the signal amplifier changes.

11. The mobile phone of claim 9 wherein the processor is capable of controlling the signal amplifier according to a power level of the receiving signal such that when the power level of the receiving signal changes, the amplification controlled by the signal amplifier changes accordingly.

12. The mobile phone of claim 1 wherein the alarming processing module stores at least a predetermined range applied with a corresponding alarming signal, wherein when the result measured by the power measuring circuit matches one of the predetermined ranges, the alarm processing module is capable of generating a corresponding alarming signal.

13. The mobile phone of claim 1 further comprising an analog-to-digital converter (ADC) electrically connected between the power measuring circuit and the alarm processing module for converting the result measured by the power measuring circuit to a digital signal.

14. The mobile phone of claim 1 further comprising:
a microphone for receiving a sound so as to generate a voice signal; and
a baseband circuit electrically connected to the microphone for generating a communication signal according to the voice signal.

15. The mobile phone of claim 1 wherein the antenna is further capable of receiving radio signals transmitted to the mobile phone and generating a corresponding receiving signal, the mobile phone further comprising:
a baseband circuit for generating a voice signal according to the receiving signal;
a speaker electrically connected to the baseband circuit for generating a sound wave according to the voice signal;
a duplexer electrically connected between the antenna and a receiving circuit for transferring the transmission signal to the antenna and transferring the receiving signal from the antenna to the power modulating circuit.
